(19) United States
(12) Patent Application Publication
(10) Pub. No.: US 2005/0091016 A1
(43) Pub. Date: Apr. 28, 2005

(54) Surface smoothing techniques

(75) Inventors: Sreenadha B. Godavarthy, Manchester, NH (US); John M. Lewis, Acton, MA (US)

Correspondence Address: GATES & COOPER LLP;HOWARD HUGHES CENTER, 6701 CENTER DRIVE WEST, SUITE 1050, LOS ANGELES, CA, 90045, US

(73) Assignee: Autodesk, Inc.

(21) Appl. No.: 10/953,806

(22) Filed: Sep. 29, 2004

Related U.S. Application Data
(60) Provisional application No. 60/507,062, filed on Sep. 29, 2003.
(60) Provisional application No. 60/507,080, filed on Sep. 29, 2003.
(60) Provisional application No. 60/506,975, filed on Sep. 29, 2003.
(60) Provisional application No. 60/506,974, filed on Sep. 29, 2003.

(51) Int. Cl. G06F 17/10

(52) U.S. Cl. 703/2

(57) ABSTRACT

A method, apparatus, and article of manufacture provide the ability to produce a smooth triangulated irregular network (TIN) surface. A TIN surface is obtained in a drawing on a GIS/CAD application. Thereafter, a surface smoothing technique is selected, such as Kriging or natural neighbor interpolation (NNI). Once interpolation output parameters are specified, additional surface points are interpolated in accordance with the selected surface smoothing technique and interpolation output parameters. The interpolated points may then be used to smooth the TIN surface.

### CROSS-REFERENCE TO RELATED APPLICATIONS

This application claims the benefit under 35 U.S.C. Section 119(e) of the following co-pending and commonly-assigned U.S. provisional patent application(s), which is/are incorporated by reference herein:
Provisional Application Ser. No. 60/507,062, filed Sep. 29, 2003, by Christopher Eric Putnam and Mark W. Anderson, entitled “PARCEL DESIGN AND PLANAR TOPOLOGY,” attorneys' docket number 30566.310-US-P1;
Provisional Application Ser. No. 60/507,080, filed Sep. 29, 2003, by Sreenadha B. Godavarthy, John M. Lewis, Thomas M Inzinga, Edward James Connor, Robert Bruce Todd, Jr., and Christopher Eric Putnam, entitled “SURFACE PROCESSING,” attorneys' docket number 30566.311-US-P1;
Provisional Application Ser. No. 60/506,975, filed Sep. 29, 2003, by Kumud Dev Vaidya, Michael C. Rogerson, and Bhamadipati S. Rao, entitled “HORIZONTAL ALIGNMENT PROCESSING,” attorneys' docket number 30566.312-US-P1; and
Provisional Application Ser. No. 60/506,974, filed Sep. 29, 2003, by Kumud Dev Vaidya, Michael C. Rogerson, and Bhamadipati S. Rao, entitled “VERTICAL ALIGNMENT PROCESSING,” attorneys' docket number 30566.313-US-P1.

This application is related to the following co-pending and commonly-assigned patent applications, all of which are incorporated by reference herein:
U.S. patent application Ser. No. ______, filed on the same date herewith, by Christopher Eric Putnam and Mark W. Anderson, entitled “METHOD FOR DYNAMICALLY UPDATING A PLANAR TOPOLOGY”, Attorney Docket No. 30566.310-US-U1;
U.S. patent application Ser. No. ______, filed on the same date herewith, by Christopher Eric Putnam and Mark W. Anderson, entitled “METHOD FOR AUTOMATICALLY DISCOVERING HIERARCHICAL RELATIONSHIPS IN PLANAR TOPLOGIES”, Attorney Docket No. 30566.361-US-U1;
U.S. patent application Ser. No. ______, filed on the same date herewith, by Christopher Eric Putnam and Mark W. Anderson, entitled “INTERACTIVE METHOD FOR DESIGNING PARCELS”, Attorney Docket No. 30566.362-US-U1;
U.S. patent application Ser. No. ______, filed on the same date herewith, by Sreenadha B. Godavarthy and John M. Lewis, entitled “SURFACE SMOOTHING TECHNIQUES”, Attorney Docket No. 30566.311-US-U1;
U.S. patent application Ser. No. ______, filed on the same date herewith, by John M. Lewis, Thomas M Inzinga and Edward James Connor, entitled “INTERACTIVE TRIANGULATED IRREGULAR NETWORK (TIN) SURFACES DESIGN”, Attorney Docket No. 30566.363-US-U1;
U.S. patent application Ser. No. ______, filed on the same date herewith, by John M. Lewis, Robert Bruce Todd, Jr., Edward James Connor, and Christopher Eric Putnam, entitled “SURFACE CONSTRUCTION AUDIT TRAIL AND MANIPULATION”, Attorney Docket No. 30566.364-US-U1;
U.S. patent application Ser. No. ______, filed on the same date herewith, by Kumud Dev Vaidya, Michael C. Rogerson, and Bhamadipati S. Rao, entitled “INTERACTIVE CONSTRAINT BASED ALIGNMENT OBJECTS”, Attorney Docket No. 30566.312-US-U1.

### BACKGROUND OF THE INVENTION

1. Field of the Invention

The present invention relates generally to computer aided design (CAD) applications and geographic information systems (GIS), and in particular, to a method, apparatus, and article of manufacture for producing a smooth surface when limited surface data is available.

2. Description of the Related Art

Computer aided design (CAD) applications are traditionally used for creating and editing drawings (e.g., maps, floor plans, and engineering designs). Further, CAD applications enable users to create/modify highly precise and accurate drawings/maps. Civil engineers and surveyors, for whom precision and accuracy are of primary importance, have adopted CAD applications to speed data input and perform computations for design projects.

Geographic information systems (GIS) have been traditionally used for spatial analysis and mapping and allow users to store, retrieve, manipulate, analyze, and display geographically referenced data. In this regard, an arc/node data model is commonly used in the GIS industry to identify a polygon that is used in land analysis. The arc/node model enables efficient data storage and users to easily determine whether an object is inside or outside a polygon. However, traditional GIS have been aimed at general cartography and broad land-use analysis, and not precision design for the construction and management of real-world projects. In this regard, the geometric precision that many engineers require has not been provided by traditional GIS systems. Some GIS companies have attempted to use complex databases to model real-world objects. However, such databases are still built on points, lines, and polygons and cannot store geoemtric objects used in traditional CAD applications (e.g., true arcs or road spirals).

Many organizations have used both CAD and GIS tools in different departments to utilize the different specific features available. Further, data from original CAD drawings may be frequently imported or digitized for use in the GIS mapping environment. However, because of the limitations of GIS systems and/or CAD systems, during such a transition, data connectivity, accuracy, and geometric precision are often lost. Accordingly, what is needed is an integrated solution that provides the functionality and tools of a GIS system with the precision and accuracy of a CAD application.

In an attempt to address the above concerns, industry specific components were built on top of the CAD engine to address specialized needs and eventually, an integrated solution was developed (e.g., Autodesk Map™ or Autodesk Land Desktop™ software available from the assignee of the present invention). Integrated solutions attempt to provide GIS functionality (e.g., multiuser editing, polygon overlay and analysis, topology, thematic mapping, etc.) within a CAD application and spatial database. The integrated solution allows civil engineers the ability to integrate the precision engineering tasks (from CAD) (e.g., site, roadway, and hydrological design) with the spatial analysis tools and data management of GIS.

Some integrated solutions may provide solutions for a particular industry or field. For example, one such integrated solution may be tailored to land development professionals to provide a base level of functionality for land planners, surveyors, civil engineers, drafters, and anyone who creates supporting documents. Such an application may also provide a streamlined ability to communicate survey data to and from the field and/or provide transportation and site engineering tools, and hydrology and hydraulics design and analysis.

Drawings in an integrated solution are often associated with one or more projects and a single project can contain one or more drawings. In this regard, land development professionals may desire to generate a model of the earth's surface for a project. Such a surface model is a three-dimensional geometric representation of the surface of an area of land. Surface models may be made up of triangles that are created when points that make up the surface data are connected. The triangles may form a triangulated irregular network (TIN) surface. A TIN line is one of the lines that makes up the surface triangulation. To create TIN lines, the surface points that are closest together may be connected.

The surface data used to obtain the surface points (i.e., for the surface map) may comprise random point data (points taken at a variety of elevations and coordinates), a selected group of points, coordinate geometry (COGO) points (e.g., COGO point data stored in an external database 110), or points imported from a file. Alternatively, coordinates from blocks or lines at elevations in a drawing may be used.

In addition to points, surfaces may also be built from DEM files (Digital Elevation Models), contour, breakline, and boundary data. The vertices of a contour may be used as surface points, or the contours may be treated as breaklines that prevent triangulation lines from crossing the contours.

To build a surface accurately, more information than points and contours must be provided. For example, to prevent surface triangulation across features such as roads or stream, breaklines may be defined. Breaklines are constraint lines used by the model that represent abrupt changes in the surface. TIN lines may be drawn to and from breakline vertices, but they do not cross the breakline. By including boundaries in the surface definition, a user can control how the surface extends to its outer limits, and internal areas may be hidden to prevent triangulation from occurring.

In addition to the above, a surface model may not accurately reflect a real-world surface in various attributes. For example, a real-world surface may be relatively smooth. However, when a surface model is created, the surface may not accurately reflect the smoothness. Such lack of smoothing may be due to limited surface data availability.

To more accurately create a smooth surface model, prior art methods have attempted to provide contour smoothing. However, in contour smoothing, the smoothing is applied to each individual contour line with no regard to adjacent contours. Such disregard often creates overlapping contours, which can become an issue with users.

In view of the above, what is needed is an integrated CAD/GIS system that provides a surface smoothing technique to provide a smoother TIN surface when limited surface data is available.

### SUMMARY OF THE INVENTION

A method, apparatus, and article of manufacture provide the ability to produce a smooth triangulated irregular network (TIN) surface when limited surface data is available. The technique adds interpolated points calculated using Kriging or natural neighbor interpolation methods.

A TIN surface is first obtained in a drawing on a GIS/CAD application/system. Thereafter, a surface object on the TIN surface is selected for editing. Once selected, the user is provided with the option to select a surface smoothing technique (i.e., Kriging or natural neighbor interpolation) and interpolation output parameters. Thereafter, additional surface points are interpolated in accordance with the selected surface smoothing technique and the interpolation output parameters. The interpolated points are then used to produce a smoother TIN surface.

If Kriging is selected as the smoothing technique, the user defines the set of surface points to be used in the Kriging. In this regard, the user may graphically select points, designate a number of points to be randomly selected by the CAD/GIS application (e.g., from an entire surface point selection), defining a polygonal object that points are selected from, or a combination of the above. The selected surface points are then displayed in a reference variogram on a point distribution diagram.

Kriging uses a semi-variogram model as a weighting function to interpolate additional points. Accordingly, the user must select a desired semi-variogram model. Such a variogram model may be an exponential model, a Gaussian model, a monomial model, a linear model, a spherical model, or other model desired. The selected semi-variogram may then be plotted on the point distribution diagram for the user to determine whether the appropriate model has been selected. Thereafter, additional points are interpolated using the model and the selected points.

Natural neighbor interpolation (NNI) is a method where a z-value of an arbitrary point P is estimated from z-values of a set of points with known z-values. In this regard, NNI uses Delaunay triangulation of a set of points to compute a weighted average of z-values of natural neighbors of an arbitrary point P. The z-value of the arbitrary point P may be computed as
C1*z(P1)+C2*z(P2)+ . . . +Ci*z(Pi)
wherein weight Ci=area(V(P) intersect V(Pi))/area(V(P)).

As part of the interpolation, the user specifies interpolation output parameters. Such output parameters may be grid-based (where points are interpolated on a grid defined within a polygonal area), triangle centroid based (where points are interpolated at existing surface triangle centroids within a polygon), and/or randomly based (where a specified number of points are interpolated randomly within or outside of a polygonal area).

### BRIEF DESCRIPTION OF THE DRAWINGS

Referring now to the drawings in which like reference numbers represent corresponding parts throughout:

FIG. 1 is an exemplary hardware and software environment used to implement one or more embodiments of the invention;

FIG. 2A illustrates an exponential semivariagram model in accordance with one or more embodiments of the invention;

FIG. 2B illustrates a Gaussian semivariagram model in accordance with one or more embodiments of the invention;

FIG. 2C illustrates a linear semivariagram model in accordance with one or more embodiments of the invention;

FIG. 2D illustrates a monomial semivariagram model in accordance with one or more embodiments of the invention;

FIG. 2E illustrates a spherical semivariagram model in accordance with one or more embodiments of the invention;

FIG. 3 is a flow chart illustrating surface smoothing in accordance with one or more embodiments of the invention;

FIG. 4 illustrates the plot of the monomial semivariogram on a point distribution diagram in accordance with one or more embodiments of the invention;

FIG. 5A illustrates a Delaunay triangulation of a set of known points in accordance with one or more embodiments of the invention;

FIG. 5B illustrates a Voronoi polygon for a point in accordance with one or more embodiments of the invention;

FIG. 5C illustrates a point that is not in the set of points in a Delaunay triangulation;

FIG. 5D illustrates the natural neighbor points for the point illustrated in FIG. 5C in accordance with one or more embodiments of the invention;

FIG. 5E illustrates Voronoi polygons without the point of FIG. 5C inserted into the Delaunay triangulation;

FIG. 5F illustrates a point inserted into a Delaunay triangulation and the resulting Voronoi polygon in accordance with one or more embodiments of the invention;

FIG. 5G illustrates Voronoi polygon intersections in accordance with one or more embodiments of the invention;

FIG. 6A illustrates a dialog window with the grid based option selected and the ability to establish parameter values in accordance with one or more embodiments of the invention;

FIG. 6B illustrates a dialog window with the triangle centroid option selected in accordance with one or more embodiments of the invention; and

FIG. 6C illustrates a dialog window with the random points option selected in accordance with one or more embodiments of the invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

Hardware Environment

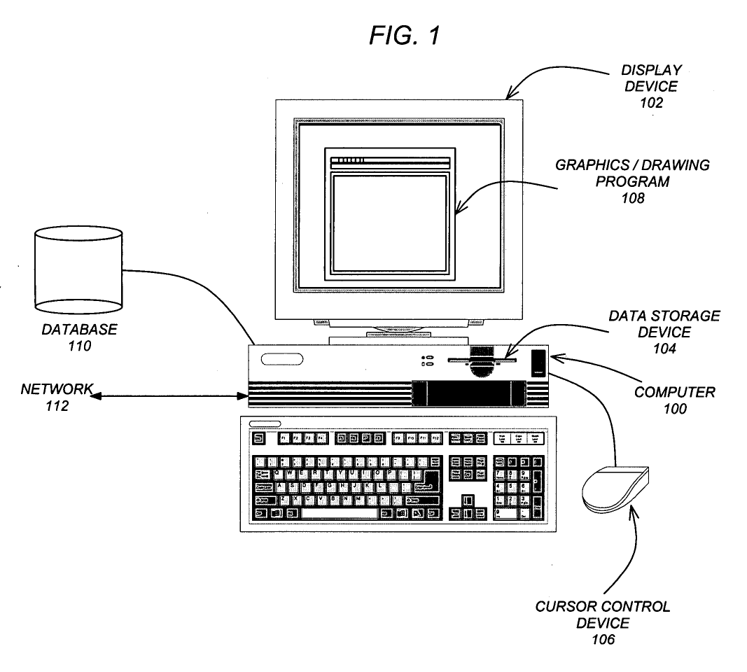

FIG. 1 is an exemplary hardware and software environment used to implement one or more embodiments of the invention. Embodiments of the invention are typically implemented using a computer 100, which generally includes, inter alia, a display device 102, data storage devices 104, cursor control devices 106, and other devices. Those skilled in the art will recognize that any combination of the above components, or any number of different components, peripherals, and other devices, may be used with the computer 100.

One or more embodiments of the invention are implemented by a computer-implemented graphics program 108 (e.g., a CAD program), wherein the graphics program 108 is represented by a window displayed on the display device 102. Generally, the graphics program 108 comprises logic and/or data embodied in or readable from a device, media, carrier, or signal, e.g., one or more fixed and/or removable data storage devices 104 connected directly or indirectly to the computer 100, one or more remote devices coupled to the computer 100 via a data communications device, etc. Further, the graphics/drawing program 108 may utilize a database 110 such as a spatial database.

Computer 100 may also be connected to other computers 100 (e.g., a client or server computer) via network 112 comprising the Internet, LANs (local area network), WANs (wide area network), or the like. Further, database 110 may be integrated within computer 100 or may be located across network 112 on another computer 100 or accessible device.

Those skilled in the art will recognize that the exemplary environment illustrated in FIG. 1 is not intended to limit the present invention. Indeed, those skilled in the art will recognize that other alternative environments may be used without departing from the scope of the present invention. Accordingly, FIG. 1 illustrates an integrated CAD and GIS system that combines the traditional capabilities of CAD and GIS tools with common spatial management features. In this regard, such an integrated solution enables the use of true geometry, precision, powerful creation and editing tools, and drawing and document production of a CAD system in addition to the GIS capabilities for polygons, topology, overlay analysis, seamless database use, and thematic mapping. Further, single or multiple users may integrate their workflow using such a system.

Software Embodiments

As described above, one or more embodiments of the invention is implemented in an integrated CAD/GIS system. The invention provides a technique for producing a smoother TIN surface when limited surface data is available. Smoothing is an operation performed on a surface object. As described in more detail below, a user-interface may be provided in which the smoothing methodology and its associated parameters can be specified, and toggled on/off. When the smoothing is toggled off, the surface object may revert back to its original state, but the smoothing parameters may be preserved as a property of the surface object.

Two different methods for surface smoothing are described herein: simple Kriging and natural neighbor interpolation. Under both of these methods, additional surface data is created by interpolating surface points.

Kriging

Kriging is a method of interpolation which predicts unknown values from data observed at known locations. The method uses variograms or semivariograms to express the spatial variation between sample data points. In other words, the variogram is a measure of how quickly things change on average. Stated differently, a variogram is a two-point statistical function that describes the increasing differences or decreasing correlation, or continuity, between sample values as separation between them increases.

A semivariagram differs from a variagram in that a semivariagram uses each pair of data elements only once, whereas a variogram uses all possible data pairs. Nonetheless, as used herein, the term variagram and semi-variagram are used interchangeably to describe both variagrams and semivariagrams. Using a variagram, the Kriging methodology minimizes the error of predicted values that are estimated by spatial distribution of the predicted values and allows extrapolation beyond the extents of the surface, based on statistical trends across the existing surface. For example, if a site contains a random sample of borehole elevations (a sparse set of data points), one can statistically extrapolate a representation of a surface.

Thus, Kriging provides a generalized method in which interpolated points are calculated from a weighted linear or combination of the data (wherein the weighting may be performed using variagrams). Weights may be determined by the following conditions:
(a) the estimation error is minimized in a mean square sense; and
(b) the estimation is unbiased. The error criterion is defined in terms of a spatial correlation model.

The Kriging (SK) interpolation may be expressed as a linear combination of the data. One or more embodiments of the invention may also utilize simple Kriging where information relating to the data are known a priori. For example, in simple Kriging, the first order component of the data may be known, and can be subtracted from the original sample to provide a set of residuals. Such a process simplifies the problem of interpolation.

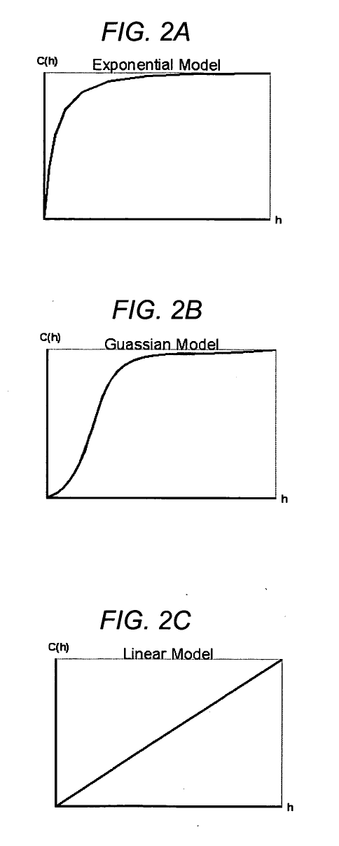

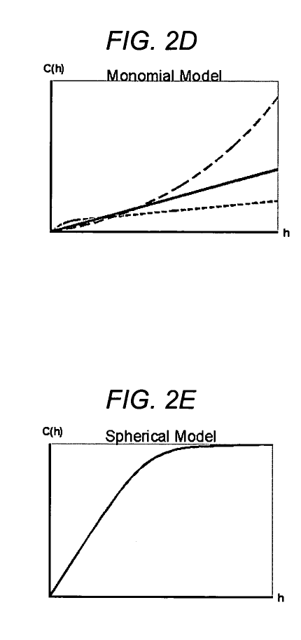

Simple kriging provides five semivariagram models that the user may choose from:
(1) Exponential;
(2) Gaussian;
(3) Monomial;
(4) Linear; and
(5) Spherical.
   The default variagram is linear. FIGS. 2A-2E illustrate the five (5) semivariagram models that the user may select in accordance with one or more embodiments of the invention. FIG. 2A illustrates an exponential semivariagram model. FIG. 2B illustrates a Gaussian semivariagram model. FIG. 2C illustrates a linear semivariagram model. FIG. 2D illustrates a monomial semivariagram model, and FIG. 2E illustrates a spherical semivariagram model.

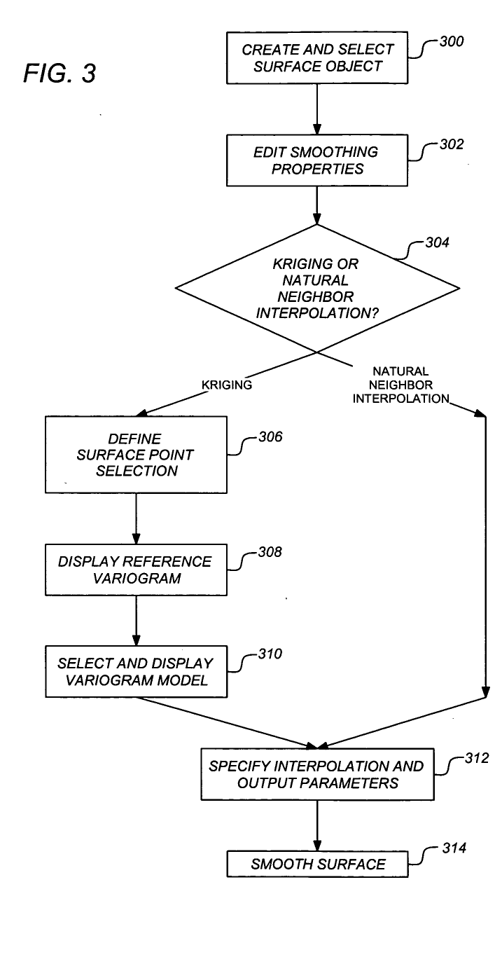

FIG. 3 is a flow chart illustrating surface smoothing in accordance with one or more embodiments of the invention. At step 300, a surface object is created and then selected for editing the surface properties. At step 302, the smoothing properties are selected for editing. In this regard, a graphical user interface may comprise various tabs with different properties on each tab available for editing by the user. To edit the smoothing properties, a smoothing tab may be selected by the user. To activate smoothing, a checkbox or other option (e.g., in the smoothing tab) may be selected to toggle on smoothing.

As described above, embodiments of the invention may provide for smoothing using either the Kriging method or natural neighbor interpolation method. Accordingly, at step 304, the user selects the desired smoothing method. Such a selection may utilize a drop list, combo box, or other graphical user interface selection method. The selection of either Kriging or natural neighbor may disable the selection of the other or the ability to edit properties of the other. For example, a drop list may be used to select a smoothing method while another area/tab of the window (or parameter listing) may provide the ability to define property values for both Kriging and natural neighbor interpolation. In such an example, if the Kriging method is selected, the area/tab of the window for defining properties for the natural neighbor interpolation may be collapsed and/or disabled (e.g., displayed in gray to indicate the inability of the user to select/define the property).

At step 304, the user has selected the Kriging smoothing method. Accordingly, a dialog/window provides the ability to define/modify various settings used by the Kriging method. At step 306, the surface point selection set (i.e., the points to be used in the smoothing calculation) is defined. Various options may be presented to the user at step 306: (1) user defined selection; (2) random; (3) region; and/or (4) all points.

For example, under option (1), the user can elect to define the selection. The user would be further prompted to select surface points. Such surface point selection may occur graphically (e.g., wherein the user selects graphically displayed points), by specifying particular coordinate data for points, by defining a window (wherein points are defined with respect to the window—e.g., points within, on, or outside of the window are automatically selected after a window has been selected/defined), or by specifying a polygon (wherein points contained within, on, or outside of a polygon are selected). Other graphical selection methods are intended to fall within the scope of the invention.

Alternatively, if the user selects option (2) the random selection set, a random amount of points may be selected from the entire surface point collection. In this regard, the user may be presented with a further option of specifying the number of points to be randomly selected.

If the user selects option (3) the region option, the surface points contained within a selected polygonal object (display region, polyline, parcel, or window) may be used.

The user can also choose to select both region (option (3)) and random (option (2)) wherein random selection would occur within a particular region (e.g., a polygon). In such a selection, the user may be prompted to select objects or parcels/surfaces that the random points are located within.

If the user selects option (4) all points for the set, all of the points in the surface are selected for the set.

Once the point set has been selected/defined, a reference variogram containing the point distribution may be displayed at step 308.

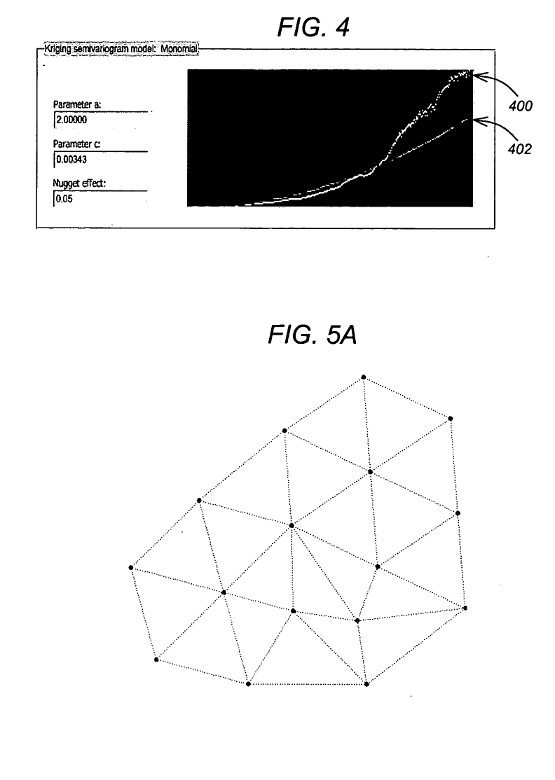

At step 310, a variogram/semivariogram to be used in the smoothing is selected and/or displayed/plotted. As described above, the default selection may be the linear semivariogram of FIG. 2C. In this regard, the default semivariogram may be displayed/plotted on the point distribution diagram with the reference variogram. When an alternative semivariogram is selected (e.g., the monomial, spherical, exponential, or Gaussian), the selected semivariogram may be plotted on the point distribution diagram. FIG. 4 illustrates the plot of the monomial semivariogram on the point distribution diagram in accordance with one or more embodiments of the invention. As illustrated, the point distribution reference variogram 400 is plotted in the same dialog/graph display with the semivariogram to be used in the smoothing-monomial semivariogram 402.

Referring back to FIG. 3, at step 312, the interpolation and output parameters are specified. As illustrated in FIG. 4, various interpolation parameters may be specified (e.g., parameter a, parameter c, and the nugget effect). As the interpolation parameters are updated, the graph display of the selected semivariagram will be updated (e.g., in real time).

In addition to those parameters displayed in FIG. 4, other point interpolation/extrapolation output parameters may also be selected (e.g., at step 312) in accordance with either the Kriging or natural neighbor methods. Such interpolation/extrapolation output parameters are discussed in more detail below.

Once the parameters have been specified, the surface smoothing is conducted at step 314. With Kriging, additional points are interpolated as part of the smoothing process by using the selected variogram model as a weighting function.

Natural Neighbor Interpolation

Natural neighbor interpolation (NNI) is a method for estimating the z-value of an arbitrary point P from the z values of a set of points with known z-values. The z-value represents the elevation at the location on the earth's surface to which the point on the TIN corresponds. The method uses information in the Delaunay triangulation of the known points to compute a weighted average of the z-values of the natural neighbors of P. Accordingly, only TIN surfaces support natural neighbor interpolation smoothing.

A Delaunay triangulation of a set of points in a plane is a set of triangles connecting the points satisfying an “empty circle” property: the circumcircle of each triangle does not contain any of the points. In other words, given a set of points, a plane can be split into various domains. One domain for which the first point is closest, another domain for which the second point is closest, etc. Such a partition is called a Voronoi diagram. If one draws a line between any two points whose Voronoi domains touch, a set of triangles is obtained, known as the Delaunay triangulation. Generally, this triangulation is unique. Further, one of the triangulation's properties is that the outcircle of every triangle does not contain any other data point.

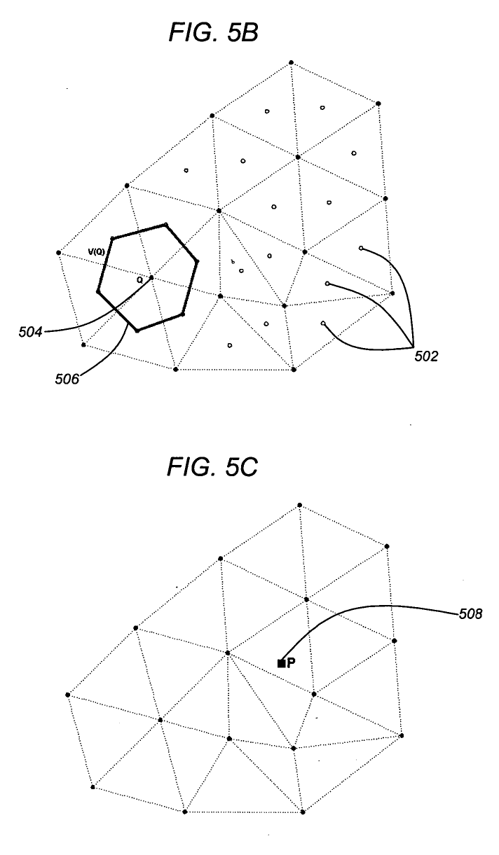

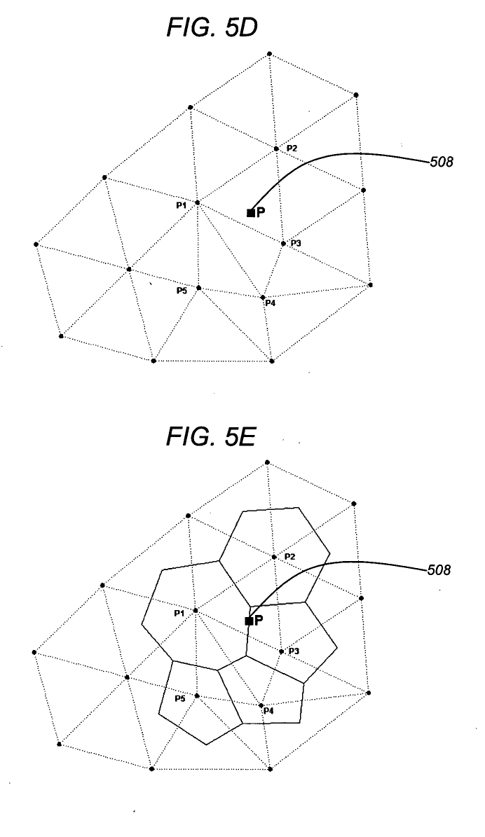

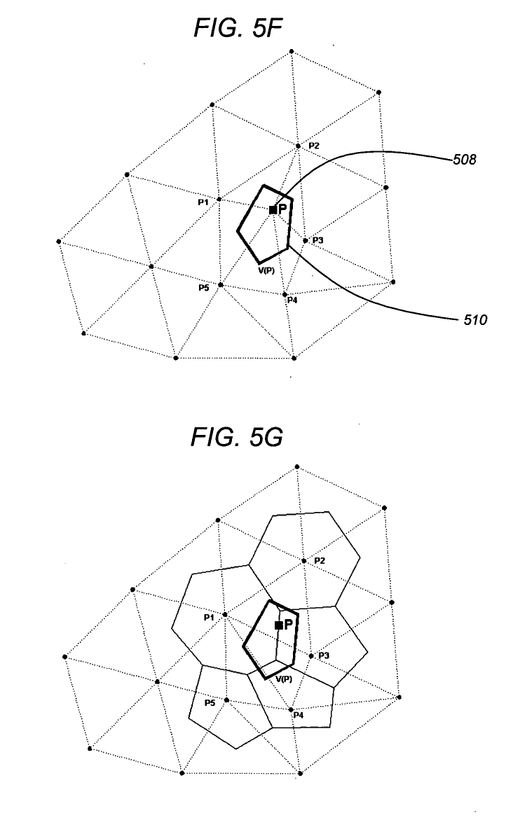

FIG. 5A illustrates the Delaunay triangulation of a set of known points. Referring now to FIG. 5B, the natural neighbors of a point are the points to which it is connected in the Delaunay triangulation of the points. If the circumcenters 502 of the triangles containing a point Q 504 are joined, the result is a polygon 506, called the Voronoi polygon of Q 504 and denoted V(Q). Accordingly, FIG. 5B illsutrates the Voronoi polygon of point Q 504.

Referring now to FIG. 5C, suppose P 508 is not in the set of points in the Delaunay triangulation. In such a case, FIG. 5D illustrates that points P1, P2, P3, P4, and P5 are point P's 508 natural neighbors, the points to which P 508 would be connected if it were inserted into the triangulation.

FIG. 5E illustrates the Voronoi polygons without P 508 inserted into the Delaunay triangulation. As used herein, V(Pi) is the Voronoi polygon of Pi in the set of points without P 508 being inserted into the Delaunay triangulation.

If point P 508 were inserted into the Delaunay triangulation, the Voronoi polygon 510 (denoted herein as V(P)) of FIG. 5F would result. Natural neighbor interpolation computes the z-value of P (denoted as z(P)) as the sum:
C1*z(P1)+C2*z(P2)+ . . . +Ci*z(Pi)
where the weight Ci=area(V(P) intersect V(Pi))/area(V(P)). In this regard, FIG. 5G illustrates the V(P) intersections with V(Pi).

Referring again to FIG. 3, the steps for using natural neighbor interpolation are similar to that of Kriging. However, at step 304, instead of selecting Kriging, the user selects NNI. Thereafter, the method proceeds to specifying the pointer interpolation/extrapolation output parameters and conducting the surface smoothing by adding the interpolated points (from the Kriging or NNI methods) to the TIN surface.

Interpolation and Output Parameters

Step 312 of FIG. 3 illustrates the step of the user specifying interpolation and output parameters. Once specified, the surface smoothing process may occur. Alternatively, as described above, the user can opt to toggle off smoothing so that the parameters and selections made are saved but smoothing does not affect the TIN/grid configuration.

Various parameters allow the user to further specify how the interpolation should occur. The first option that may be specified is that of output locations. The output locations parameter allow the user to specify where/how points are output after/during interpolation. Options for the output location include grid based, triangle centroid, and random points.

Grid Based Option

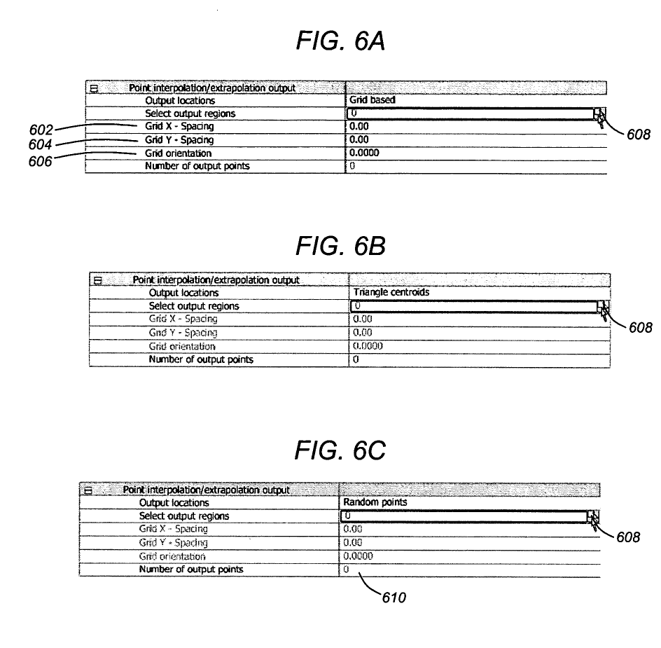

The grid based option is used to interpolate surface points (NNI mode) or interpolate/extrapolate surface points (Kringing mode) on a grid defined within specified polygon areas selected in the drawing. Accordingly, once the grid based option is selected, the user may be further prompted to define/specify one or more polygon areas. After the areas are defined, further parameters for the grid may be specified. FIG. 6A illustrates a dialog window with the grid based option selected and the ability to establish parameter values in accordance with one or more embodiments of the invention. After the areas are defined, the Grid X-Spacing 602, Grid Y-Spacing 604 and Grid Orientation 606 parameter values may be specified.

When the pick button 608 is selected in the select output regions edit box, the user is provided with the ability to define the interpolation/extrapolation areas. Such selection ability may be provided through a command line or graphical user interface. The areas may be specified by object, parcel, window, polygon, or surface.

If the object area is selected, the user defines/specifies the object/object area that interpolation/extrapolation will occur within. Valid objects may include parcels, polylines, and region objects. Other objects may be filtered from the selection set. To define the areas, the user may select the various objects using a cursor or be specifying objects through a command line. Thus, the user may specify/select a particular parcel, polyline, or region within which the interpolation/extrapolation will occur.

If the user selects the parcel option, the user defines/selects a parcel that is used in the interpolation/extrapolation.

The window option may be used to define a window (e.g., using two points selected from a drawing editor or coordinate information) for the interpolation area.

The polygon option is used to define a polygon (e.g., with a minimum of three points selected using a drawing editor or coordinate information) for the interpolation area. To define the polygon, commonly used methods for polygon selection defining may be utilized.

The surface option may be used to indicate the entire surface area is to be used as the interpolation area.

As indicated above, the orientation of the grid 606 may be specified using degrees or other methods (e.g., icons that show a rotated grid orientation).

Triangle Centroid Option

The triangle centroid option (i.e., as an output location) is used to interpolate points (NNI mode and Kriging mode) at the existing triangle centroids within specified polygon areas selected in the drawing. FIG. 6B illustrates a dialog window with the triangle centroid option selected. As can be seen in FIG. 6B, the Grid X—Spacing 602, Grid Y—Spacing 604, and Grid Orientation controls (used in FIG. 6A) may be disabled when the triangle centroid option is active.

Similar to the grid-based option, the user may select the pick button 608 to specify the output regions to be used in the interpolation. The same options as those described above may be available during such selection.

Random Points Option

The random points option is used to interpolate, or interpolated/extrapolate (Kriging mode) a specified number of random points within polygon areas selected in the drawing. FIG. 6C illustrates a dialog window with the random points option selected. Similar to the triangle centroid option, the Grid X—Spacing 602, Grid Y—Spacing 604, and Grid Orientation controls (used in FIG. 6A) may be disabled when the random points option is active. Further, similar to FIGS. 6A and 6B, the user may select the pick button 608 to specify the output regions to be used in the interpolation with the same options as those described above.

In addition, with the random points option, the user has the ability to specify the number of random output points 610 that are to be interpolated.

Once the various output locations and parameters have been specified, the TIN smoothing may be conducted at step 314 in accordance with the specified selections. Thus, the user can elect to smooth a TIN surface using Kriging in which semivariograms are used to calculate points, or using natural neighbor methodology in which z-values are estimated based on known z-values from neighboring points.

Conclusion

This concludes the description of the preferred embodiment of the invention. The following describes some alternative embodiments for accomplishing the present invention. For example, any type of computer, such as a mainframe, minicomputer, or personal computer, or computer configuration, such as a timesharing mainframe, local area network, or standalone personal computer, could be used with the present invention. In summary, embodiments of the invention provide a method for producing a smoother TIN surface when limited surface data is available. The technique adds interpolated points calculated using Kriging or natural neighbor interpolation.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

1. A method for producing a smooth triangulated irregular network (TIN) surface, comprising:
obtaining a TIN surface in a drawing on a GIS/CAD application;
selecting a surface smoothing technique;
specifying interpolation output parameters;
interpolating additional surface points in accordance with the selected surface smoothing technique and interpolation output parameters; and
smoothing the TIN surface using the interpolated additional surface points.

2. The method of claim 1, wherein the surface smoothing technique comprises Kriging.

3. The method of claim 2, further comprising:
defining surface selection points;
displaying a reference variogram on a point distribution diagram;
selecting a semi-variogram model;
plotting the selected semi-variogram model on the point distribution diagram; and
interpolating additional points to be used to smooth the TIN surface by using the selected semi-variogram model as a weighting function.

4. The method of claim 3, wherein defining surface selection points comprises a user graphically selecting surface points.

5. The method of claim 3, wherein defining surface selection points comprises the CAD/GIS application randomly selecting a defined number of points from an entire surface point selection.

6. The method of claim 3, wherein defining surface selection points comprises selecting points contained within a selected polygonal object.

7. The method of claim 3, wherein the semi-variogram model is selected from a group consisting of exponential, Gaussian, monomial, linear, and spherical.

8. The method of claim 1, wherein the surface smoothing technique comprises natural neighbor interpolation wherein a z-value of an arbitrary point P is estimated from z-values of a set of points with known z-values.

9. The method of claim 8, wherein information in a Delaunay triangulation of the set of points is used to compute a weighted average of z-values of natural neighbors of the arbitrary point P.

10. The method of claim 9, wherein the z-value of P is computed as:
C1*z(P1)+C2*z(P2)+ . . . +Ci*z(Pi)
wherein weight Ci=area(V(P) intersect V(Pi))/area(V(P)).

11. The method of claim 1, wherein the interpolation output parameters comprise a grid based output location wherein the surface points are interpolated on a grid defined within specified polygon areas selected in the drawing.

12. The method of claim 1, wherein the interpolation output parameters comprise a triangle centroid output location wherein surface points are interpolated at existing surface triangle centroids within specified polygon areas selected in the drawing.

13. The method of claim 1, wherein the interpolation output parameters comprise a random points output location wherein a specified number of surface points are interpolated randomly within polygon areas selected in the drawing.

14. An apparatus for producing a smooth triangulated irregular network (TIN) surface in a computer system comprising:
(a) a computer system having a memory and a data storage device coupled thereto;
(b) a GIS/CAD application executing on the computer, wherein the application is configured to:
(i) obtain a TIN surface in a drawing on the GIS/CAD application;
(ii) select a surface smoothing technique;
(iii) specify interpolation output parameters;
(iv) interpolate additional surface points in accordance with the selected surface smoothing technique and interpolation output parameters; and
(v) smooth the TIN surface using the interpolated additional surface points.

15. The apparatus of claim 14, wherein the surface smoothing technique comprises Kriging.

16. The apparatus of claim 15, wherein the application is further configured to:
define surface selection points;
display a reference variogram on a point distribution diagram;
select a semi-variogram model;
plot the selected semi-variogram model on the point distribution diagram; and
interpolate additional points to be used to smooth the TIN surface by using the selected semi-variogram model as a weighting function.

17. The apparatus of claim 16, wherein the application is configured to define surface selection points by a user graphically selecting surface points.

18. The apparatus of claim 16, wherein the application is configured to define surface selection points by randomly selecting a defined number of points from an entire surface point selection.

19. The apparatus of claim 16, wherein the application is configured to define surface selection points by selecting points contained within a selected polygonal object.

20. The apparatus of claim 16, wherein the semi-variogram model is selected from a group consisting of exponential, Gaussian, monomial, linear, and spherical.

21. The apparatus of claim 14, wherein the surface smoothing technique comprises natural neighbor interpolation wherein a z-value of an arbitrary point P is estimated from z-values of a set of points with known z-values.

22. The apparatus of claim 21, wherein information in a Delaunay triangulation of the set of points is used to compute a weighted average of z-values of natural neighbors of the arbitrary point P.

23. The apparatus of claim 22, wherein the z-value of P is computed as:
C1*z(P1)+C2*z(P2)+ . . . +Ci*z(Pi)
wherein weight Ci=area(V(P) intersect V(Pi))/area(V(P)).

24. The apparatus of claim 14, wherein the interpolation output parameters comprise a grid based output location wherein the surface points are interpolated on a grid defined within specified polygon areas selected in the drawing.

25. The apparatus of claim 14, wherein the interpolation output parameters comprise a triangle centroid output location wherein surface points are interpolated at existing surface triangle centroids within specified polygon areas selected in the drawing.

26. The apparatus of claim 14, wherein the interpolation output parameters comprise a random points output location wherein a specified number of surface points are interpolated randomly within polygon areas selected in the drawing.

27. An article of manufacture comprising a program storage medium readable by a computer and embodying one or more instructions executable by the computer to perform a method for smoothing a triangulated irregular network (TIN) surface in an GIS/CAD computer system, the method comprising:
obtaining a TIN surface in a drawing on the GIS/CAD application;
selecting a surface smoothing technique;
specifying interpolation output parameters;
interpolating additional surface points in accordance with the selected surface smoothing technique and interpolation output parameters; and
smoothing the TIN surface using the interpolated additional surface points.

28. The article of manufacture of claim 27, wherein the surface smoothing technique comprises Kriging.

29. The article of manufacture of claim 28, wherein the method further comprises:
defining surface selection points;
displaying a reference variogram on a point distribution diagram;
selecting a semi-variogram model;
plotting the selected semi-variogram model on the point distribution diagram; and
interpolating additional points to be used to smooth the TIN surface by using the selected semi-variogram model as a weighting function.

30. The article of manufacture of claim 29, wherein defining surface selection points comprises a user graphically selecting surface points.

31. The article of manufacture of claim 29, wherein defining surface selection points comprises the CAD/GIS application randomly selecting a defined number of points from an entire surface point selection.

32. The article of manufacture of claim 29, wherein defining surface selection points comprises selecting points contained within a selected polygonal object.

33. The article of manufacture of claim 29, wherein the semi-variogram model is selected from a group consisting of exponential, Gaussian, monomial, linear, and spherical.

34. The article of manufacture of claim 27, wherein the surface smoothing technique comprises natural neighbor interpolation wherein a z-value of an arbitrary point P is estimated from z-values of a set of points with known z-values.

35. The article of manufacture of claim 34, wherein information in a Delaunay triangulation of the set of points is used to compute a weighted average of z-values of natural neighbors of the arbitrary point P.

36. The article of manufacture of claim 35, wherein the z-value of P is computed as:
C1*z(P1)+C2*z(P2)+ . . . +Ci*z(Pi)
wherein weight Ci=area(V(P) intersect V(Pi))/area(V(P)).

37. The article of manufacture of claim 27, wherein the interpolation output parameters comprise a grid based output location wherein the surface points are interpolated on a grid defined within specified polygon areas selected in the drawing.

38. The article of manufacture of claim 27, wherein the interpolation output parameters comprise a triangle centroid output location wherein surface points are interpolated at existing surface triangle centroids within specified polygon areas selected in the drawing.

39. The article of manufacture of claim 27, wherein the interpolation output parameters comprise a random points output location wherein a specified number of surface points are interpolated randomly within polygon areas selected in the drawing.
